(19) United States
(12) Patent Application Publication
(10) Pub. No.: US 2026/0132063 A1
(43) Pub. Date: May 14, 2026

(54) ANTI-BIOFILM DEVICES AND METHODS FOR LIQUID STORAGE TANKS

(71) Applicant: Blue Origin Manufacturing, LLC, Huntsville, AL (US)

(72) Inventor: John P. Stanford, Kent, WA (US)

(21) Appl. No.: 19/387,317

(22) Filed: Nov. 12, 2025

Related U.S. Application Data
(60) Provisional application No. 63/720,109, filed on Nov. 13, 2024.

(51) Int. Cl. C02F 1/72; B01J 21/06; C02F 1/32; C02F 101/30

(52) U.S. Cl. CPC C02F 1/725; B01J 21/063; C02F 1/325; C02F 2101/30; C02F 2201/3222; C02F 2303/04; C02F 2305/023; C02F 2305/10

(57) ABSTRACT

Apparatuses and methods of removing or preventing a biofilm in containers are provided. In one aspect, the anti-biofilm apparatus includes a container wall including an external surface, an internal surface, a UV transparent layer, a porous hydrophobic layer, and a UV catalyst layer disposed between the UV transparent layer and the porous hydrophobic layer. The apparatus can include a light source configured to transmit UV light through the UV transparent layer. The UV light can interact with gaseous water in the UV catalyst layer and the porous hydrophobic layer to form a hydroxyl species that can reduce or prevent formation of a biofilm on the internal surface of the container wall.

### INCORPORATION BY REFERENCE TO ANY PRIORITY APPLICATIONS

Any and all applications for which a domestic priority claim is identified in the Application Data Sheet as filed with the present application are hereby incorporated by reference. This application claims the benefit of U.S. Provisional Application No. 63/720,109, filed on November 13, 2024, which is incorporated by reference herein in its entirety for all purposes.

### TECHNICAL FIELD

The present disclosure relates generally to anti-biofilm devices, systems, and methods. More particularly, the present disclosure relates to anti-biofilm devices configured to remove biofilms from an inside surface of a storage container.

### BACKGROUND

Space stations typically store water in tanks and containers for extended periods of time. Such water storage tanks are prone to microbial growth and the formation of biofilms on the walls of the tanks. Various methods are utilized to mitigate biofilm growth, which include the use of chemical biocides and anti-microbial chemicals (for example, iodine, chlorine, bleach, ionic silver, peroxides, strong acids/bases), surfactants, mechanical cleaning, and through high temperature/high pressure treatments (for example, autoclaving). However, these methods come at a cost in space station environments of either chemical consumables, potential toxicity concerns, mechanical tools/crew time, draining and accessing the container, and/or significant power for high temperature/pressure.

### SUMMARY

The embodiments disclosed herein each have several aspects no single one of which is solely responsible for the present disclosure’s desirable attributes. Without limiting the scope of the present disclosure, its more prominent features will now be briefly discussed. After considering this discussion, and particularly after reading the section entitled “Detailed Description” one will understand how the features of the embodiments described herein provide advantages over existing systems and methods for providing propulsion using hydrogen and oxygen.

In one aspect, an anti-biofilm apparatus is provided. The apparatus includes a container wall including an external surface, an internal surface, a UV transparent layer, wherein the UV transparent layer includes a first side and a second side, and wherein the first side defines at least a portion of the external surface, a porous hydrophobic layer, wherein the porous hydrophobic layer includes a third side and a fourth side, and wherein the fourth side defines at least a portion of the internal surface, and a UV catalyst layer disposed between the UV transparent layer and the porous hydrophobic layer. The apparatus also includes a light source configured to transmit UV light through the first side of the UV transparent layer.

In some embodiments, the UV transparent layer includes fluorinated ethylene propylene (FEP).

In some embodiments, the UV catalyst layer includes a titanium dioxide mesh.

In some embodiments, the porous hydrophobic layer is permeable to a gas and substantially impermeable to a liquid.

In some embodiments, the gas includes gaseous water and the liquid includes liquid water.

In some embodiments, the porous hydrophobic layer includes an expanded polytetrafluoroethylene (ePTFE).

In some embodiments, the light source is an LED UV light source.

In some embodiments, the container wall is a flexible wall of a tank or a bag configured to store a liquid.

In some embodiments, the UV catalyst layer and the porous hydrophobic layer are configured to remove or prevent organic matter from forming on the internal surface of the container wall.

In another aspect, a device is provided. The device includes one or more walls defining a volume in which a liquid can be stored, a portion of at least one wall including a UV transparent layer, wherein the UV transparent layer includes a first side and a second side, and wherein the first side defines an external surface of the portion of the at least one wall, a porous hydrophobic layer, wherein the porous hydrophobic layer includes a third side and a fourth side, and wherein the fourth side defines at an internal surface of the portion of the at least one wall, and a UV catalyst layer disposed between the UV transparent layer and the porous hydrophobic layer.

In some embodiments, the UV catalyst layer and the porous hydrophobic layer are configured to remove or prevent organic matter from forming on the internal surface of the portion of the at least one wall.

In some embodiments, the device is a flexible container configured to store liquid water.

In another aspect, a system is provided. The system includes a device as described herein. The system also includes a light source configured to transmit UV light through the first side of the UV transparent layer. The system further includes a pump configured to pump liquid contained in the device to a tank.

In some embodiments, the device includes a container including an inlet in fluid communication with the pump and an outlet in fluid communication with the tank.

In another aspect, a method of removing or preventing a biofilm using an apparatus described herein is provided. The method includes exposing the fourth side of the porous hydrophobic layer to liquid water thereby transporting gaseous water to the UV catalyst layer. The method also includes emitting UV light from the UV light source through the first side of the UV transparent layer to the UV catalyst layer. The method further includes reacting the gaseous water and the UV light to form a hydroxyl species, wherein the hydroxyl species is transported to the fourth side of the porous hydrophobic layer.

In some embodiments, the hydroxyl species is selected from the group consisting of hydroxyl ions, hydroxyl radicals, and combinations thereof.

In some embodiments, the method further includes reacting the hydroxyl species with organic matter.

In some embodiments, the organic matter is disposed on the fourth side of the porous hydrophobic material.

In some embodiments, the method further includes transporting the hydroxyl species and the liquid water to the organic matter.

In some embodiments, the organic matter is selected from the group consisting of a biofilm, bacteria, organic molecules, and combinations thereof.

### BRIEF DESCRIPTION OF THE DRAWINGS

In some drawings, various structures according to embodiments of the present disclosure are schematically shown. However, the drawings are not necessarily drawn to scale, and some features may be enlarged while some features may be omitted for the sake of clarity. The relative dimensions and proportions as shown are not intended to limit the present disclosure. It will be readily understood that the aspects of the present disclosure, as generally described herein, and illustrated in the figures, can be arranged, substituted, combined, and designed in a wide variety of different configurations, all of which are explicitly contemplated and make part of this disclosure.

FIG. 1A is a schematic illustration of an embodiment of an anti-biofilm device according to the present disclosure.

FIG. 1B is a cross-sectional schematic illustration of an embodiment of an anti-biofilm apparatus according to the present disclosure.

FIG. 2 is a schematic illustration of a container system including an anti-biofilm apparatus according to the present disclosure.

FIG. 3 is a schematic illustration of an embodiment of a system including an anti-biofilm device according to the present disclosure.

FIG. 4 is a cross-sectional schematic illustration of an embodiment of an anti-biofilm device that can be implemented in the system of FIG. 3 according to the present disclosure.

### DETAILED DESCRIPTION

Embodiments of the present disclosure include systems, apparatuses, devices, and methods that use expose a catalyst to ultraviolet (UV) light to generate a hydroxyl species from water, where the hydroxyl species can be reacted with biofilms, bacteria and/or organic matter. Reacting the hydroxyl species with the biofilm mitigates, inhibits, removes, reduces, prevents, and/or aids in preventing biofilm growth on an inner surface or within a volume of a container, such as a water storage container. Surface biofilm growth is a notorious challenge for water systems that store water for extended durations, such as water systems of spacecrafts and space stations that undergo extended periods of dormancy and/or intermittent habitation by crew. In some embodiments, the anti-biofilm devices according to the present disclosure can be integrated into the container itself or within a separate device recirculating water from the container.

The systems, apparatuses, and devices according to the present disclosure include a UV transparent layer (for example, fluorinated ethylene propylene (“FEP”)), a UV catalyst layer (for example, a titanium dioxide mesh), and a porous hydrophobic layer (for example, a porous expanded polytetrafluoroethylene (“ePTFE”) membrane). When the UV transparent layer is exposed to UV light and the porous hydrophobic layer is in contact with liquid water, the UV light interacts with the UV catalyst layer to generate a chemically reactive hydroxyl species that then permeates through the porous hydrophobic layer to react with the liquid water. The reactive hydroxyl species in the liquid water can interact with a biofilm (for example, bacteria and/or organic matter) that it comes into contact with, thereby oxidizing organic molecules of the biofilm. Through such oxidation of the biofilm on an internal surface of the container, the container can remain free of biofilms or biofilms can be substantially reduced.

As a result, embodiments of the present disclosure can eliminate and/or prevent significant biological and/or biofilm growth in water storage tanks and other containers. In some embodiments, such results may be achieved without the need for using caustic or otherwise hazardous chemicals, without the use of elevated temperatures or otherwise extreme conditions, and/or without significant extra mass and/or volume compared to conventional water storage tanks. Furthermore, such results may be achieved with the use of low power UV light (for example, provided by flexible low energy LEDs), and in some embodiments may be used on an intermittent, or as needed, frequency and/or duration to remove or prevent biofilm accumulation. As such, embodiments of the present disclosure can significantly reduce or eliminate the need to resupply the space station or spacecraft with external sources typically used to sanitize water storage tanks. Embodiments of the present disclosure can also be advantageously implemented in conjunction with water storage tanks and containers that are not located in space such as, but not limited to, water tanks and containers used in recreational vehicle, marine, and camping contexts.

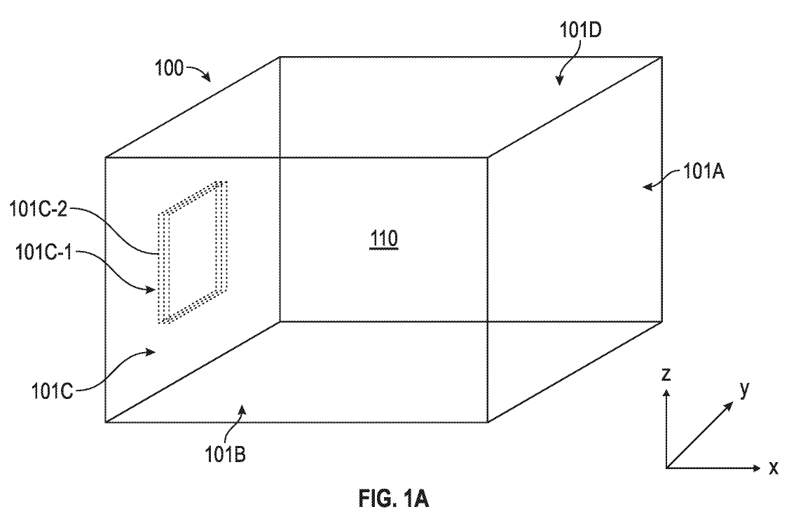

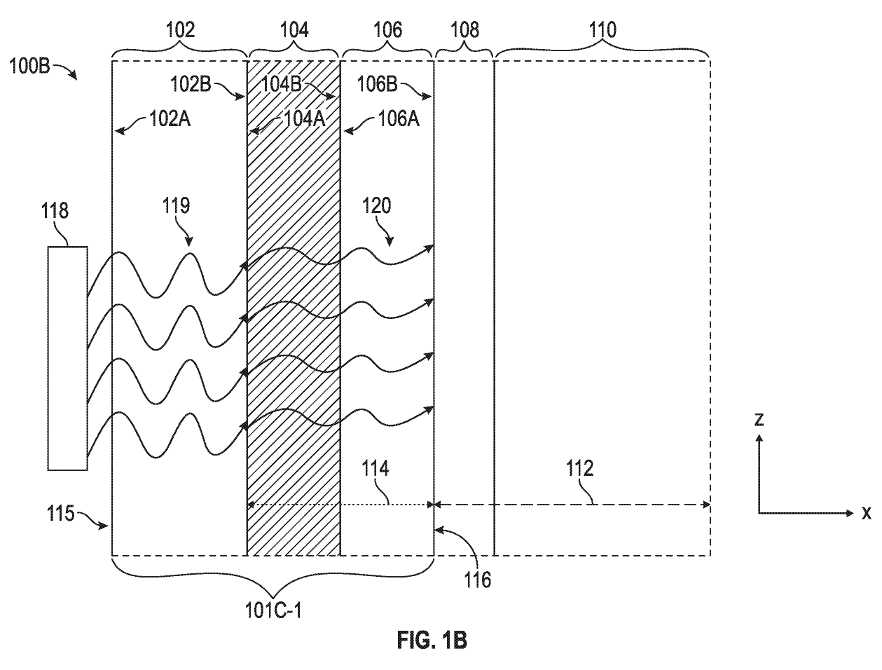

FIG. 1A is a schematic illustration of an embodiment of an anti-biofilm device 100 according to the present disclosure. The device 100 can include one or more walls 101 defining a volume 110. A liquid, such as liquid water, can be contained, stored, or held in the volume 110. The device 100 in this non-limiting example is a container having a plurality of walls 101 that define a volume 110 in which a liquid can be stored. It will be understood, however, that the device 100 can be any device configured to contain, store, or hold a liquid, including but not limited to a container, a vessel, a receptacle, a bag, or any other suitable structure. For example, in another non-limiting embodiment of the present disclosure, the device 100 is a bag including a single wall 101 or a plurality of walls 101 joined together. The bag may be formed of flexible material(s) that contain, store, or hold a liquid.

A portion 101C-1 of at least one of the walls 101C can include a plurality of layers 101C-2 configured to reduce or prevent formation of a biofilm. In this example, only the portion 101C-1 of a wall 101C includes the plurality of layers 101C-2, but it will be understood that all or substantially all portions of any of the walls 101 can include the plurality of layers 101C-2. For example, all or substantially all of the wall 101C may be formed of a material that includes the plurality of layers 101C-2. In another example, all or substantially all of the wall 101A may be formed of a material that includes the plurality of layers 101C-2. In still another example, all or substantially all of the wall 101B may be formed of a material that includes the plurality of layers 101C-2. It will also be understood that some but not all walls 101 may include the plurality of layers 101C-2. For example, walls 101, or portions of walls 101, that are configured to contact the liquid may include the plurality of layers 101C-2. In one non-limiting embodiment, a top wall 101D of the device 100 may not include the plurality of layers 101C-2. It will be understood that embodiments of the device 100 can have any suitable dimensions.

FIG. 1B is a cross-sectional schematic illustration of an embodiment of an anti-biofilm apparatus 100B according to the present disclosure. The apparatus 100B can implement anti-biofilm devices according to the present disclosure, for example the anti-biofilm device 100 described above with reference to FIG. 1A. The apparatus 100B can include a container wall 101C, for example the container wall 101C of the anti-biofilm device 100 described with reference to FIG. 1A. The container wall 101C can include the plurality of layers 101C-2 configured to reduce or prevent formation of a biofilm. The apparatus 100B can also include a light source 118 configured to transmit UV light to the container wall 101C.

A portion 101C-1 of the container wall 101C is illustrated for ease of understanding, but it will be understood that the apparatus 100B can include any features described above with reference to FIG. 1A. For example, all or substantially all of the wall 101C may include the plurality of layers 101C-2. All or substantially all of the wall 101C may be formed of a material that includes the plurality of layers 101C-2. As another example, the apparatus 100B can include a container having one or more walls 101 that define a volume 110 configured to contain, store, or hold a liquid, and a portion 101C-1 of at least one wall 101 including a plurality of layers 101C-2 configured to reduce or prevent formation of a biofilm. The container can be configured to contain, store, or hold a liquid, such as liquid water. It will be understood that any liquid, not just liquid water, can be contained, stored, or held in containers according to the present disclosure.

The portion 101C-1 of the wall 101C includes an external surface 115 and an internal surface 116. The internal surface 116 can be an internal surface of a container defining a volume 110. A biofilm 108 has formed on the internal surface 116 in this non-limiting example. It will be understood, however, that the apparatus 100B need not include a biofilm 108 formed on the internal surface 116. Embodiments of anti-biofilm devices according to the present disclosure can reduce, prevent, or aid in preventing the formation of the biofilm 108 that has formed on the internal surface 116. In embodiments of the apparatuses 100B in which a biofilm 108 has not formed on the internal surface 116, embodiments of anti-biofilm devices according to the present disclosure can prevent the formation of a biofilm 108 on the internal surface 116.

The portion 101C-1 of the wall 101C includes a UV transparent layer 102 with a first side 102A and a second side 102B. The first side 102A of the UV transparent layer 102 can define the external surface 115 of the wall 101C. Other configurations of the wall 101C can be suitably implemented. For example, an additional layer formed on the first side 102A of the UV transparent layer 102 can define the external surface 115 of the wall 101C. The UV transparent layer 102 can be formed of a material that is transparent to UV light. The UV transparent layer 102 can include a material that is configured to transmit all or substantially all light having wavelengths between about 100nm and about 400nm. The UV transparent layer 102 can include any suitable material that is transmissive to UV light. In some examples, the UV transparent layer 102 is configured to transmit other non-UV wavelengths of light in addition to transmitting UV wavelengths of light. In some non-limiting embodiments of the present disclosure, the UV transparent layer 102 may include fluorinated ethylene propylene (“FEP”), polyvinylchloride (“PVC”), polymethyl methacrylate (“PMMA”), or combinations thereof. In one non-limiting embodiment of the present disclosure, the UV transparent layer 102 includes fluorinated ethylene propylene (“FEP”).

The portion 101C-1 of the wall 101C also includes a porous hydrophobic layer 106 with a third side 106A and a fourth side 106B. The fourth side 106B of the porous hydrophobic layer 106 can define the internal surface 116 of the wall 101C. Other configurations of the wall 101C can be suitably implemented. For example, a layer formed on the fourth side 106B of the porous hydrophobic layer 106 can define the internal surface 116 of the wall 101C. The porous hydrophobic layer 106 can be formed of a material that is permeable to gases, ions, and/or radicals. For example, the porous hydrophobic layer 106 can be formed of a material may includes pores with sufficiently small pore sizes to prevent the intrusion of liquid water, but large enough to easily allow the permeation of gases, ions, and/or radicals. As another example, the porous hydrophobic layer 106 may provide relatively high permeability to gases, ions, and/or radicals and provide relatively low permeability to liquid water. The porous hydrophobic layer 106 can be formed of a material that is impermeable to a liquid, such as a hydrophilic liquid (for example, liquid water). The porous hydrophobic layer 106 can include a material that is hydrophobic to liquid water. The porous hydrophobic layer 106 can include any suitable material that is permeable to gaseous water and impermeable to liquid water. In one non-limiting embodiment of the present disclosure, the porous hydrophobic layer 106 includes polytetrafluoroethylene (“PTFE”). In some non-limiting embodiments of the present disclosure, the porous hydrophobic layer 106 includes an expanded polytetrafluoroethylene (“ePTFE”), fluorinated high-density polyethylene (“HDPE”), polyvinylidene fluoride (“PVDF”) (for example, Kynar®), or combinations thereof. In another non-limiting embodiment of the present disclosure, the porous hydrophobic layer 106 is a porous expanded polytetrafluoroethylene (“ePTFE”) membrane or layer.

The portion 101C-1 of the wall 101C further includes a UV catalyst layer 104 with a fifth side 104A and a sixth side 104B. The UV catalyst layer 104 can be disposed between the UV transparent layer 102 and the porous hydrophobic layer 106. The UV catalyst layer 104 can be formed of a material that reacts with water (for example, gaseous water) in the presence of UV light to form reactive compounds, such as hydroxyl species (for example, hydroxyl radicals). Furthermore, the UV catalyst layer 104 can be formed of a material that is mechanically flexible and permeable or substantially permeable to gases. In some examples, the UV catalyst layer 104 is formed of a plurality of fibers, wherein individual fibers of the plurality of fibers are sufficiently thick and/or strong to maintain the shape of the UV catalyst layer 104 without or without substantial mechanical failure, such as mechanical fracture or breakage. In some non-limiting embodiments of the present disclosure, the UV catalyst layer 104 includes titanium dioxide (TiO₂), zinc oxide (ZnO), iron oxide (Fe₂O₃), tin oxide (SnO₂), zirconium oxide (ZrO₂), cerium oxide (CeO₂), tungsten oxide (WO₃), vanadium oxide (V₂O₅), or combinations thereof. In one non-limiting embodiment of the present disclosure, the UV catalyst layer 104 includes titanium dioxide. In some non-limiting embodiments of the present disclosure, the UV catalyst layer 104 includes a titanium dioxide mesh, a zinc oxide mesh, an iron oxide mesh, a tin oxide mesh, a zirconium oxide mesh, a cerium oxide mesh, a tungsten oxide mesh, a vanadium oxide mesh, or combinations thereof. In another non-limiting embodiment of the present disclosure, the UV catalyst layer 104 is a titanium dioxide mesh. In still another non-limiting embodiment of the present disclosure, the UV catalyst layer 104 is a photoactive catalyst material.

Liquid water held within the volume 110 is able to move from the volume 110 into the biofilm 108 and to move from the biofilm 108 to the volume 110. Liquid water held within the volume 110 can permeate the biofilm 108. Liquid water can move in a liquid water zone 112 between the volume 110 and the biofilm 108. The liquid water zone 112 can terminate at the internal surface 116 of the wall 101C. In the non-limiting embodiment of FIG. 1B where the fourth side 106B of the porous hydrophobic layer 106 defines the internal surface 116 of the wall 101C, the liquid water zone 112 can terminate at the fourth side 106B of the porous hydrophobic layer 106. Liquid water that has moved into the biofilm 108 and comes into contact with the fourth side 106B of the porous hydrophobic layer 106 is not able to pass through the fourth side 106B due to the hydrophobic properties of the porous hydrophobic layer 106. Liquid water that is in contact with the fourth side 106B is not able to permeate through the porous hydrophobic layer 106.

In contrast to liquid water which is generally confined to the liquid water zone 112, gaseous water can permeate layers of the portion 101C-1 of the wall 101C. Gaseous water may be spontaneously formed in the liquid water at or near the internal surface 116 due to liquid-vapor equilibrium conditions at a given temperature and pressure. Gaseous water can permeate the porous hydrophobic layer 106 and the UV catalyst layer 104. Gaseous water can move in a gaseous water zone 114 between the fourth side 106B of the porous hydrophobic layer 106 and the fifth side 104A of the UV catalyst layer 104. It will be understood that embodiments of the present disclosure are not limited to gaseous water permeating layers of the portion 101C-1 of the wall 101C. For example, water vapor can permeate layers of the portion 101C-1 of the wall 101C. It will also be understood that although liquid water zone 112 and gaseous water zone 114 are depicted in two dimensions in FIG. 1B for ease of understanding, the liquid and gaseous water zones 112 and 114 are three dimensional zones that can extend into and out of the page of FIG. 1B.

The light source 118 is configured to emit UV light 119 to the wall 101C. The light source 118 can emit UV light 119 through the external surface 115 of the portion 101C-1 of the wall 101C. For example, UV light 119 can enter the portion 101C-1 of the wall 101C at the first side 102A of the UV transparent layer 102. The UV light 119 can travel through the UV transparent layer 102 to the second side 102B of the UV transparent layer 102. The UV light 119 can irradiate the UV catalyst layer 104. For example, the UV light 119 can irradiate the fifth side 104A of the UV catalyst layer 104 and pass through the UV catalyst layer 104 to the sixth side 104B. UV light 119 can irradiate gaseous water and/or water vapor in the gaseous water zone 114 to form hydroxyl species 120 with the aid of the UV catalyst layer 104. The hydroxyl species 120 can be generated in any location of the portion 101C-1 of the wall 101C where gaseous water and/or water vapor is irradiated by UV light and in contact or close proximity with the UV catalyst layer 104. For example, the hydroxyl species 120 can be generated in any location of the gaseous water zone 114. The hydroxyl species 120 can move or be transported through the gaseous water zone 114 to the internal surface 116 of the wall 101C. For example, the hydroxyl species 120 can move or be transported through the UV catalyst layer 104 and/or the porous hydrophobic layer 106 to the fourth side 106B of the porous hydrophobic layer 106. The hydroxyl species 120 transported to the internal surface 116 of the wall 101C may contact and react with the biofilm 108 and/or enter the volume 110. The light source 118 can be any UV light source. For example, the light source 118 can include a light emitting diode (LED), a lamp, a laser, and combinations thereof.

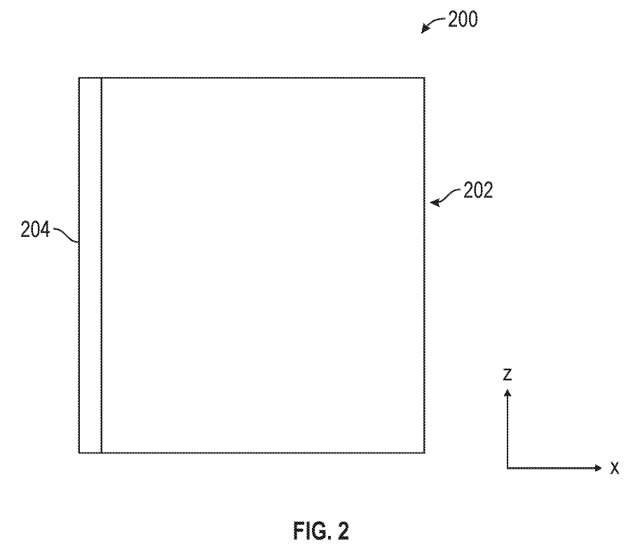

FIG. 2 is a schematic illustration of a system 200 including an anti-biofilm device 204 according to an embodiment of the present disclosure. The system 200 also includes a container 202. The container 202 can be any device configured to contain, store, or hold a liquid including, but not limited to, a container, a vessel, a receptacle, a bag, or any other suitable structure. The container 202 can include features that are substantially similar to features described above with reference to the device 100. The anti-biofilm device 204 can form a surface of the container 202. For example, the anti-biofilm device 204 can form a portion of a wall of a plurality of walls of the container 202. In another non-limiting example, the anti-biofilm device 204 can be coupled to, attached to, or formed on a portion of a wall of a plurality of walls of the container 202. The anti-biofilm device 204 can generate a hydroxyl species that is released into a volume of the container 202, such that biofilms on the internal surface(s) defining the volume of the container 202 may be removed or prevented. The system 200 can implement anti-biofilm devices according to the present disclosure, for example the anti-biofilm device 100 described above with reference to FIG. 1A. One or more walls of the container 200 can include features of the wall 101C of the anti-biofilm device 100 described with reference to FIG. 1A and/or features of the wall 101C of the apparatus 100B described with reference to FIG. 1B.

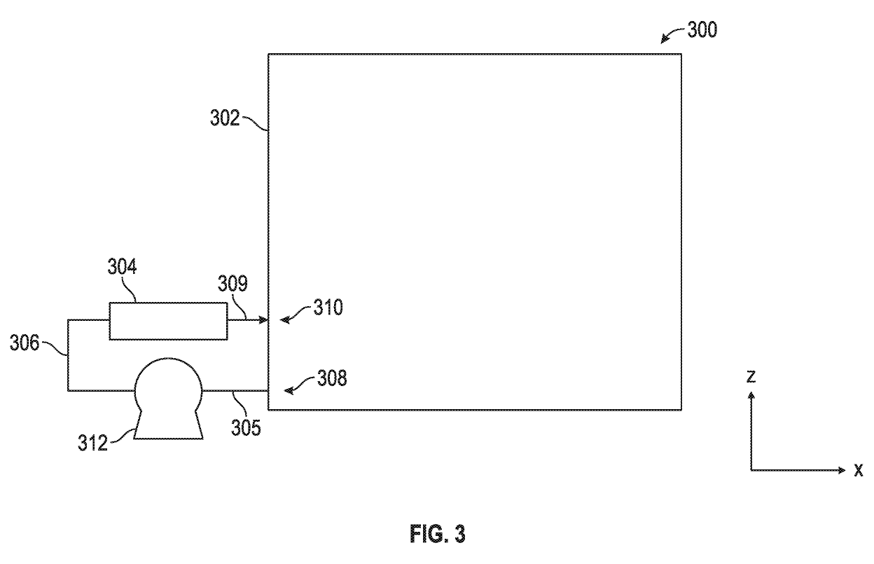

FIG. 3 is a schematic illustration of a system 300 according to an embodiment of the present disclosure. The system 300 can include a tank 302 and an anti-biofilm device 304 external to the tank 302. Although embodiments of the system 300 are described with reference to a tank 302, it will be understood that the tank 302 can be any device configured to contain, store, or hold a liquid, including but not limited to a container, a vessel, a receptacle, a bag, or any other suitable structure. The anti-biofilm device 304 can include features that are substantially similar to features described above with reference to the anti-biofilm device 100 and the anti-biofilm device 204. The anti-biofilm device 304 can be configured to contain, store, or hold a liquid. The anti-biofilm device 304 can include a container, a vessel, a receptacle, a bag, or any other suitable structure. The anti-biofilm device 304 can also include a light source (not illustrated) configured to emit UV light to a wall (not illustrated) of the anti-biofilm device 304. The wall can include features that are substantially similar to features described above with reference to the wall 101C and the wall of the plurality of walls of the container 202. The light source can include features that are substantially similar to features described above with reference to the light source 118. For example, the light source 118 can be configured to transmit UV light through the first side of the UV transparent layer of the anti-biofilm device 304.

The system 300 can also include a pump 312 configured to pump a liquid that is contained, stored, or held in the tank 302 to the anti-biofilm device 304. The liquid contained, stored, or held in the tank 302 can be pumped through an outlet 308 of the tank 302 to the tank. In the non-limiting embodiment of FIG. 3, the system 300 includes a fluid line 305 configured to fluidly connect the pump 312 to the tank 302. In the non-limiting embodiment of FIG. 3, the system 300 includes a fluid line 306 configured to fluidly connect the pump 312 to the anti-biofilm apparatus 304. The pump 312 can also be configured to pump a liquid that is contained, stored, or held in the anti-biofilm device 304 to the tank 302. In the non-limiting embodiment of FIG. 3, the system 300 includes a fluid line 309 configured to fluidically connect the anti-biofilm device 304 to the tank 302. The liquid contained, stored, or held in the anti-biofilm device 304 can be pumped through an inlet 310 of the tank 302. As the pump 312 transports fluid from the outlet 308 and through the anti-biofilm apparatus 304, the anti-biofilm apparatus 304 can produce and release a hydroxyl species to form a treated fluid. The treated fluid including the hydroxyl species may be returned to the tank 302 through the inlet 310 such that biofilms on the internal surface(s) of the tank 302 may be removed or prevented from forming.

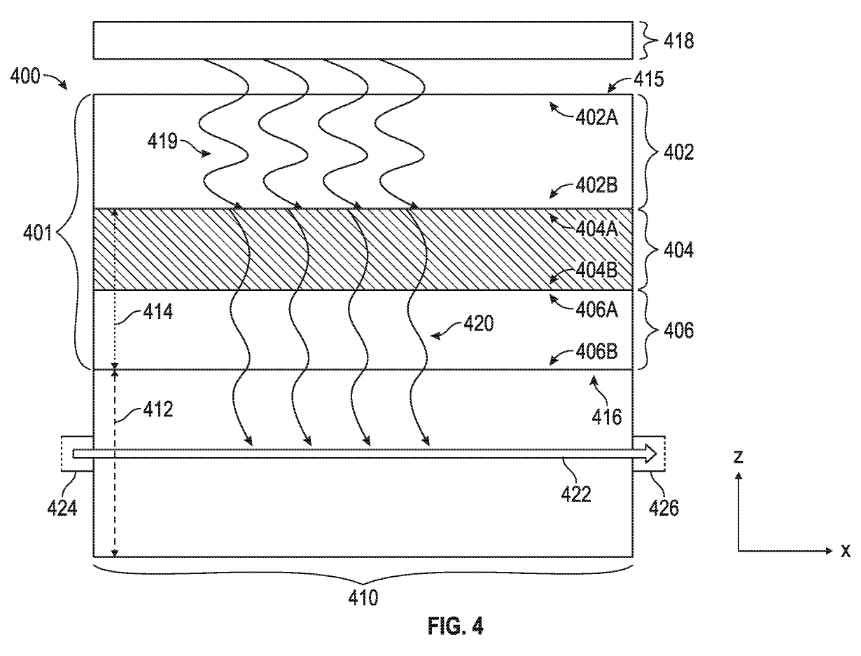

FIG. 4. is a cross-sectional schematic illustration of an embodiment of an anti-biofilm device 400 that can be implemented in the system of FIG. 3 according to the present disclosure. As described above with reference to FIG. 3, the anti-biofilm device 400 can be external to a tank and configured to reduce or prevent formation of a biofilm on an internal surface of the tank. The anti-biofilm device 400 can include features that are substantially similar to features described above with reference to the anti-biofilm device 100, the anti-biofilm device 204, and the anti-biofilm device 304. The anti-biofilm device 400 can be configured to contain, store, or hold a liquid, including but not limited to a container, a vessel, a receptacle, a bag, or any other suitable structure. The anti-biofilm device 400 can include a light source 418 configured to emit UV light 419 to a wall 401 of the anti-biofilm device 400. The light source 418 can include features that are substantially similar to features described above with reference to the light source 118. For example, the light source 418 can be configured to transmit UV light 419 through the first side 415 of the UV transparent layer 402 of the anti-biofilm device 400. The wall 401 can include features that are substantially similar to features described above with reference to the wall 101C and the wall of the plurality of walls of the container 202.

The anti-biofilm device 400 can include a channel 410. The channel 410 is configured to contain, store, or hold a liquid. The liquid can be, for example, liquid water. The channel 410 can include an inlet 424 and an outlet 426. The wall 401 can include an external surface 415, an internal surface 416, a UV transparent layer 402 with a first side 402A and a second side 402B, a porous hydrophobic layer 406 with a third side 406A and a fourth side 406B, and a UV catalyst layer 404 with a fifth side 404A and a sixth side 404B. The first side 402A of the UV transparent layer can define the external surface 415 of the device 400. The fourth side 406B of the porous hydrophobic layer 406 can define the internal surface 416. The UV catalyst layer 404 can be disposed between the second side 402B of the UV transparent layer 402 and the third side 406A of the porous hydrophobic layer 406.

Liquid water may enter the channel 410 through the inlet 424. The liquid water can generally follow a water flow path 422 illustrated schematically in FIG. 4. The liquid water can flow to the outlet 426. The liquid water can exit the channel 410 at the outlet 426. The liquid water may move through the channel 410 in a liquid water zone 412. Liquid water can move in the liquid water zone 412 and into contact with the fourth side 406B of the porous hydrophobic layer 406. The liquid water zone 412 can terminate at the internal surface 416 of the wall 401. At the internal surface 416, the liquid water zone 412 can end as liquid water is not able to permeate through the porous hydrophobic layer 406. However, gaseous water from liquid water is able to permeate the porous hydrophobic layer 406 and the UV catalyst layer 404. Gaseous water can move in a gaseous water zone 414 between the fourth side 406B of the porous hydrophobic layer 406 and the fifth side 404A of the UV catalyst layer 404. It will be understood that although liquid water zone 412 and gaseous water zone 414 are depicted in two dimensions in FIG. 4 for ease of understanding, the liquid and gaseous water zones 412 and 414 are three dimensional zones that can extend into and out of the page of FIG. 4.

The light source 418 can be configured to emit UV light 419 through the external surface 415 and into the UV transparent layer 402. Th light source 418 can be configured to irradiate the UV catalyst layer 404 and gaseous water in the gaseous water zone 414 to form hydroxyl species 420. The hydroxyl species 420 can move or be transported through the UV catalyst layer 404 and the porous hydrophobic layer 406. The hydroxyl species 420 can move or be transported to the internal surface 416. The hydroxyl species 420 can move into the water flow path 422 to form a treated fluid. The treated fluid including hydroxyl species 420 may exit the container channel through the outlet 426 to react with organic matter external to the apparatus 400, such as a biofilm in the container 302 of the system in FIG. 3.

### Implementing Systems and Terminology

Implementations disclosed herein provide systems, methods, and devices for removing and/or preventing biofilms in containers. One skilled in the art will recognize that these embodiments may be implemented in hardware or a combination of hardware and software and/or firmware.

The methods disclosed herein include one or more steps or actions for achieving the described method. The method steps and/or actions may be interchanged with one another without departing from the scope of the present disclosure. In other words, unless a specific order of steps or actions is required for proper operation of the method that is being described, the order and/or use of specific steps and/or actions may be modified without departing from the scope of the present disclosure.

With respect to the use of substantially any plural and/or singular terms herein, those having skill in the art can translate from the plural to the singular and/or from the singular to the plural as is appropriate to the context and/or application.

The above description discloses several methods and systems of the present disclosure. Embodiments of the present disclosure are susceptible to modifications in the methods and systems, as well as alterations in the fabrication methods and equipment. Such modifications will become apparent to those skilled in the art from a consideration of this disclosure or practice of the present disclosure. Consequently, it is to be understood that embodiments presented herein are by way of example and not by way of limitation. The intent of the above detailed description, although discussing exemplary embodiments, is to be construed to cover all modifications, alternatives, and equivalents of the embodiments as may fall within the spirit and scope of the present disclosure. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the figures may be combined, interchanged or excluded from other embodiments.

Any feature or combination of features described herein are included within the scope of the present disclosure provided that the features included in any such combination are not mutually inconsistent as will be apparent from the context, this description, and the knowledge of one skilled in the art. In addition, any feature or combination of features may be specifically excluded from any embodiment of the present disclosure. For purposes of summarizing the present disclosure, certain aspects, advantages, and novel features of the present disclosure are described herein. Of course, it is to be understood that not necessarily all such aspects, advantages, or features will be present in any particular embodiment of the present disclosure.

As will be appreciated, structures and/or regions may be present beyond the illustrated sections shown (for example, beyond the horizontal and/or vertical extension shown). It may further be noted that the relative dimensions of the shown structures, for instance the relative thickness of layers, are merely schematic and may, for the purpose of illustrational clarity, differ from a physical device structure.

By a first feature such as a layer, a level or other structure, being positioned or formed “on” or “disposed over” a second feature such as a layer, a level or other structure, is hereby meant that the first feature may be formed directly on the second feature (that is, in abutment with the second feature) or with one or more layers or structures intermediate the first and the second feature (that is, not in direct contact with the second feature, unless explicitly stated otherwise).

What is claimed is:

1. An anti-biofilm apparatus comprising:
a container wall comprising
an external surface,
an internal surface,
a UV transparent layer, wherein the UV transparent layer comprises a first side and a second side, and wherein the first side defines at least a portion of the external surface,
a porous hydrophobic layer, wherein the porous hydrophobic layer comprises a third side and a fourth side, and wherein the fourth side defines at least a portion of the internal surface, and
a UV catalyst layer disposed between the UV transparent layer and the porous hydrophobic layer; and
a light source configured to transmit UV light through the first side of the UV transparent layer.

2. The apparatus of claim 1, wherein the UV transparent layer comprises fluorinated ethylene propylene (FEP).

3. The apparatus of claim 1, wherein the UV catalyst layer comprises a titanium dioxide mesh.

4. The apparatus of claim 1, wherein the porous hydrophobic layer is permeable to a gas and substantially impermeable to a liquid.

5. The apparatus of claim 4, wherein the gas comprises gaseous water and the liquid comprises liquid water.

6. The apparatus of claim 1, wherein the porous hydrophobic layer comprises an expanded polytetrafluoroethylene (ePTFE).

7. The apparatus of claim 1, wherein the light source is an LED UV light source.

8. The apparatus of claim 1, wherein the container wall is a flexible wall of a tank or a bag configured to store a liquid.

9. The apparatus of claim 1, wherein the UV catalyst layer and the porous hydrophobic layer are configured to remove or prevent organic matter from forming on the internal surface of the container wall.

10. A device comprising:
one or more walls defining a volume in which a liquid can be stored, a portion of at least one wall comprising:
a UV transparent layer, wherein the UV transparent layer comprises a first side and a second side, and wherein the first side defines an external surface of the portion of the at least one wall,
a porous hydrophobic layer, wherein the porous hydrophobic layer comprises a third side and a fourth side, and wherein the fourth side defines at an internal surface of the portion of the at least one wall, and
a UV catalyst layer disposed between the UV transparent layer and the porous hydrophobic layer.

11. The device of claim 10, wherein the UV catalyst layer and the porous hydrophobic layer are configured to remove or prevent organic matter from forming on the internal surface of the portion of the at least one wall.

12. The device of claim 10, wherein the device is a flexible container configured to store liquid water.

13. A system comprising:
the device of claim 10;
a light source configured to transmit UV light through the first side of the UV transparent layer; and
a pump configured to pump liquid contained in the device to a tank.

14. The system of claim 13, wherein the device comprises a container comprising an inlet in fluid communication with the pump and an outlet in fluid communication with the tank.

15. A method of removing or preventing a biofilm using the apparatus of claim 1, comprising:
exposing the fourth side of the porous hydrophobic layer to liquid water thereby transporting gaseous water to the UV catalyst layer;
emitting UV light from the UV light source through the first side of the UV transparent layer to the UV catalyst layer; and
reacting the gaseous water and the UV light to form a hydroxyl species, wherein the hydroxyl species is transported to the fourth side of the porous hydrophobic layer.

16. The method of claim 15, wherein the hydroxyl species is selected from the group consisting of hydroxyl ions, hydroxyl radicals, and combinations thereof.

17. The method of claim 15, further comprising reacting the hydroxyl species with organic matter.

18. The method of claim 17, wherein the organic matter is disposed on the fourth side of the porous hydrophobic material.

19. The method of claim 17, further comprising transporting the hydroxyl species and the liquid water to the organic matter.

20. The method of claim 17, wherein the organic matter is selected from the group consisting of a biofilm, bacteria, organic molecules, and combinations thereof.
